(19) United States
(12) Patent Application Publication
(10) Pub. No.: US 2016/0239841 A1
(43) Pub. Date: Aug. 18, 2016

(54) METHOD, APPARATUS, AND SYSTEM FOR SECURE ONLINE PAYMENT

(71) Applicant: GUANGZHOU UCWEB COMPUTER TECHNOLOGY CO., LTD., Guangzhou (CN)

(72) Inventors: Bingqiang CAO, Guangzhou (CN); Liang WU, Guangzhou (CN); Xiang ZENG, Guangzhou (CN)

(21) Appl. No.: 15/011,013

(22) Filed: Jan. 29, 2016

(30) Foreign Application Priority Data
Feb. 15, 2015 (CN) 201510085289.6

(51) Int. Cl. G06Q 20/40

(52) U.S. Cl. CPC G06Q 20/405

(57) ABSTRACT

A secure payment processing method is disclosed. The method can be implemented by a client terminal device. The method comprises receiving payment response data indicating that a payment has been completed by a settlement server and having a signature conforming to a predefined rule; sending the payment response data to a payment verification server; receiving a verification result from the payment verification server, the verification result indicating whether the payment response data has the signature conforming to the predefined rule; and determining, according to the verification result, whether the payment has been completed in the settlement server.

### CROSS REFERENCE TO RELATED APPLICATION

The present application is based on and claims the benefits of priority to Chinese Application No. 201510085289.6, filed Feb. 15, 2015, the entire contents of which are incorporated herein by reference.

### TECHNICAL FIELD

The present application relates to methods, apparatus, and systems for secure online payment.

### BACKGROUND

With the development of Internet, more and more applications, for example, game applications, can run on client terminal devices such as computers and smart phones. Especially with increasing use of smart phones, various applications based on smart phones are becoming popular in people's life.

Many applications involve transactions. For example, a user may purchase a virtual or real asset or service, in an application. The purchase can be conducted with a virtual currency or a game prop. For another example, a Google In-APP Billing payment method has been integrated in payment systems of current Android-based mobile devices. In particular, it is used by paid applications that need access to Google Play application store.

However, it is found at times that although a client has generated a lot of orders and a corresponding game content provider (CP) has also delivered ordered game items, the Google server end does not receive any of the orders or user payment. This situation can cause losses for the game content provider (CP).

FIG. 1 is a schematic diagram illustrating an existing transaction system 100. When a user wants to perform transaction, a payment request is sent from a client terminal device 10 (such as a smart phone) to a settlement server 20 (such as a Google store server).

For example, an application (such as a game application) on the client terminal device 10 may communicate, by process-to-process communication (such as a Binder), with a Google store application that also runs on the client terminal device 10. In response to a request of the user for purchasing a certain item in the related application (for example, the user clicks an icon or text of a certain item in the application), the application communicates with the Google store application, and sends a payment request to the Google store server through the Google store application. The Google settlement server 20 completes payment in response to the payment request, and returns payment response data to the client terminal device 10. The payment response data represents that payment has been completed in the settlement server 20. Moreover, the payment response data has a Google signature, which is used for verifying the authenticity of the payment response data.

For example, in response to the payment request from the client terminal device 10, the Google store server may complete the payment according to a predetermined settlement procedure, and returns the payment response data to the Google store application on the client terminal device 10.

Next, the Google store application returns the payment response data to the (game) application by broadcasting. The client terminal device 10 determines, based on the payment response data, whether the payment has been completed. For example, the (game) application on the client terminal device 10 starts a payment service, to verify the payment response data and makes a response according to the verification result. When it is determined that payment has been completed, the application may further communicate with an application server 40 (such as a game server), to obtain the item that has been purchased (such as a virtual or real asset or service).

On one hand, the client terminal device 10 communicates with the settlement server 20, to complete payment. On the other hand, the client terminal device 10 communicates with the application server 40, to complete delivery of the item.

In some cases, the application installed on the client terminal device 10 may not have a corresponding application server, i.e., the application only has a client part, but does not have a server end part, and the transaction system includes only the client terminal device 10 and the settlement server 20. In this case, fees may also need to be paid, but the delivery of the corresponding item is not performed by the application server 40.

In some other cases, for example, a charitable donation through an application, it is possible that only fees need to be paid, while no item needs to be delivered.

Therefore, although the accompanying drawings of the document of the present disclosure show the application server 40, it is possible, in the secure payment processing system (or even in the whole transaction system), that the application server 40 is not involved.

Not all (game) applications have a server end, and not all (game) applications can perform server-to-server communication. Therefore, the Google In-APP Billing is a payment method based on process-to-process communication of the client, relying on client broadcasting and Binder. This may be exploited by malicious applications.

In an Android client, process-to-process communication data can be forged. For example, communication data sent by “another Google server” and a payment sequence can be simulated, to become unrecognizable to the game application.

However, it is difficult to simulate Google payment response data. Some so-called “in-app purchase tools”, such as the famous Freedom.apk application, try to avoid Google security verification by bypassing a Google security verification module that verifies the payment response data. An attack process of the Freedom is as follows:

1: Use the Freedom to start a certain (game) application.

2: Establish a simple HTTP server locally by modifying a Host file using a ROOT privilege, and forward a request to this server.

3: When a user clicks a certain game item to purchase it, the (game) application initiates a payment request to an Android store application.

4: The Freedom intercepts the payment request at this time, and forges a payment response (however, the payment data does not conform to a data signature rule of a Google order) by the HTTP server.

5: Broadcast the payment response data into the (game) application.

6: After receiving the broadcast, the (game) application starts a payment service and runs a Google security verification module.

7: At this time, the Freedom forges a signature main function of the Google security module, and enables the function to return a result indicating that the signature is correct with any data input to the function.

8: After signature verification is forged, the game (application), when called back, recognizes the data as authenticate data returned by Google. The item or game prop (for example, a purchased level or purchased health) is delivered according to the forged data information with no real payment.

The described cheating solution makes the application unable to verify the authenticity of the payment response or perform a corresponding processing operation, thus causing losses (application items and game props) to (game) application developers, and seriously affecting security of the payment system.

To improve the security of the payment system, and protect interests of (game) application developers and payment effectiveness of a payment software development kit (SDK), it is necessary to provide a solution to prevent the signature authentication forgery and to ensure secure (online) payment (e.g., Google In-App Billing).

### SUMMARY

One aspect of the present disclosure is directed to a secure payment processing method. The method can be implemented by a client terminal device. The method comprises receiving payment response data indicating that a payment has been completed by a settlement server and having a signature conforming to a predefined rule, sending the payment response data to a payment verification server, receiving a verification result from the payment verification server, the verification result indicating whether the payment response data has the signature conforming to the predefined rule, and determining, according to the verification result, whether the payment has been completed in the settlement server.

Another aspect of the present disclosure is directed to an apparatus for performing secure payment processing. The apparatus comprises a first receiving unit configured to receive payment response data indicating that a payment has been completed in a settlement server and having a signature conforming to a predefined rule, a sending unit configured to send the payment response data to a payment verification server, a second receiving unit configured to receive a verification result from the payment verification server, the verification result indicating whether the payment response data has the signature conforming to the predefined rule, and a payment determining unit configured to determine, according to the verification result, whether the payment has been completed in the settlement server.

Another aspect of the present disclosure is directed to a secure payment processing method. The method comprises sending, by a client terminal device, a payment request to a settlement server, completing, by the settlement server, a payment in response to the payment request and sending, by the settlement server, corresponding payment response data to the client terminal device, the payment response data indicating that the payment has been completed in the settlement server and having a signature conforming to a predefined rule, sending, by the client terminal device, the payment response data to a payment verification server, verifying, by the payment verification server, whether the payment response data has the signature conforming to the predefined rule, sending, by the payment verification server, a verification result to the client terminal device, and determining, by the client terminal device and according to the verification result, whether the payment has been completed in the settlement server.

Another aspect of the present disclosure is directed to a secure payment processing system. The system comprises a client terminal device configured to send a payment request to a settlement server, the settlement server configured to complete a payment in response to the payment request and to send corresponding payment response data to the client terminal device, the payment response data indicating that the payment has been completed in the settlement server and having a signature conforming to a predefined rule, and a payment verification server configured to receive, from the client terminal device, the corresponding payment response data, to verify whether the payment response data has the signature conforming to the predefined rule, and to send a verification result to the client terminal device. The client terminal device is further configured to determine, according to the verification result, whether the payment has been completed in the settlement server.

Additional features and advantages of the present disclosure will be set forth in part in the following detailed description, and in part will be obvious from the description, or may be learned by practice of the present disclosure. The features and advantages of the present disclosure will be realized and attained by means of the elements and combinations particularly pointed out in the appended claims.

It is to be understood that the foregoing general description and the following detailed description are exemplary and explanatory only, and are not restrictive of the invention, as claimed.

### BRIEF DESCRIPTION OF THE DRAWINGS

The accompanying drawings, which constitute a part of this specification, illustrate several embodiments and, together with the description, serve to explain the disclosed principles.

FIG. 1 is an exemplary secure online payment system in the prior art.

FIG. 2 is a flow diagram illustrating a secure online payment system, according to an exemplary embodiment.

FIG. 3 is a flow diagram illustrating a secure online payment method, according to an exemplary embodiment.

FIG. 4 is a flow diagram illustrating another secure online payment system, according to an exemplary embodiment.

FIG. 5 is a flow diagram illustrating another secure online payment system, according to an exemplary embodiment.

FIG. 6 is a flow diagram illustrating another secure online payment system, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

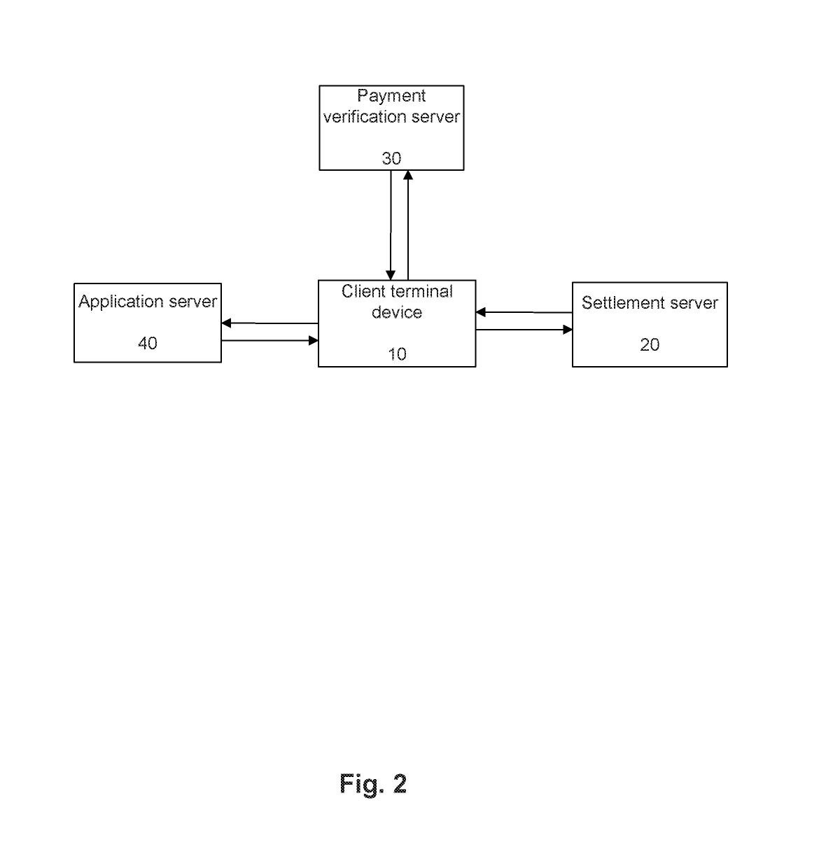

A transaction system according to an embodiment of the present disclosure is described with reference to FIG. 2. FIG. 2 is a flow diagram illustrating a secure online payment system 200, according to an exemplary embodiment. Transaction system 200 includes a client terminal device 10, a settlement server 20, a payment verification server 30, and an application server 40. The client terminal device 10 can implement payment transactions by communicating with the settlement server 20 and the payment verification server 30. The client terminal device 10 can deliver an item (e.g. a purchased game item) or service by communicating with the application server 40. Some of the components, for example, the application server 40, of the payment system 200, may be optional.

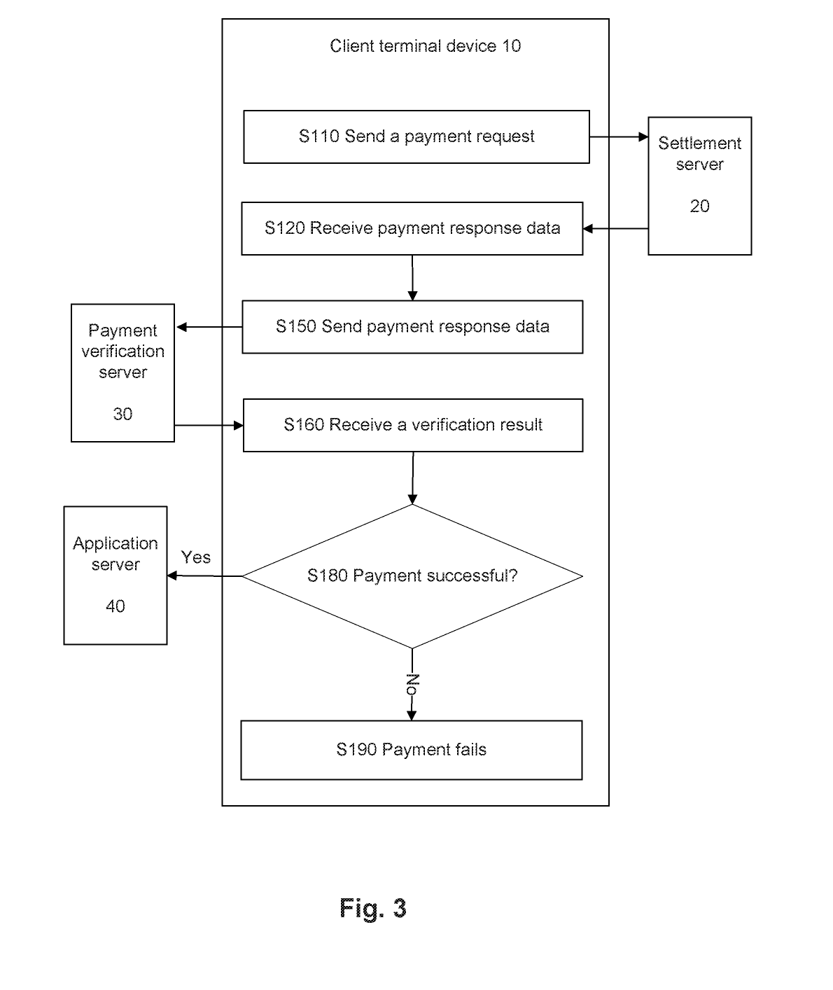

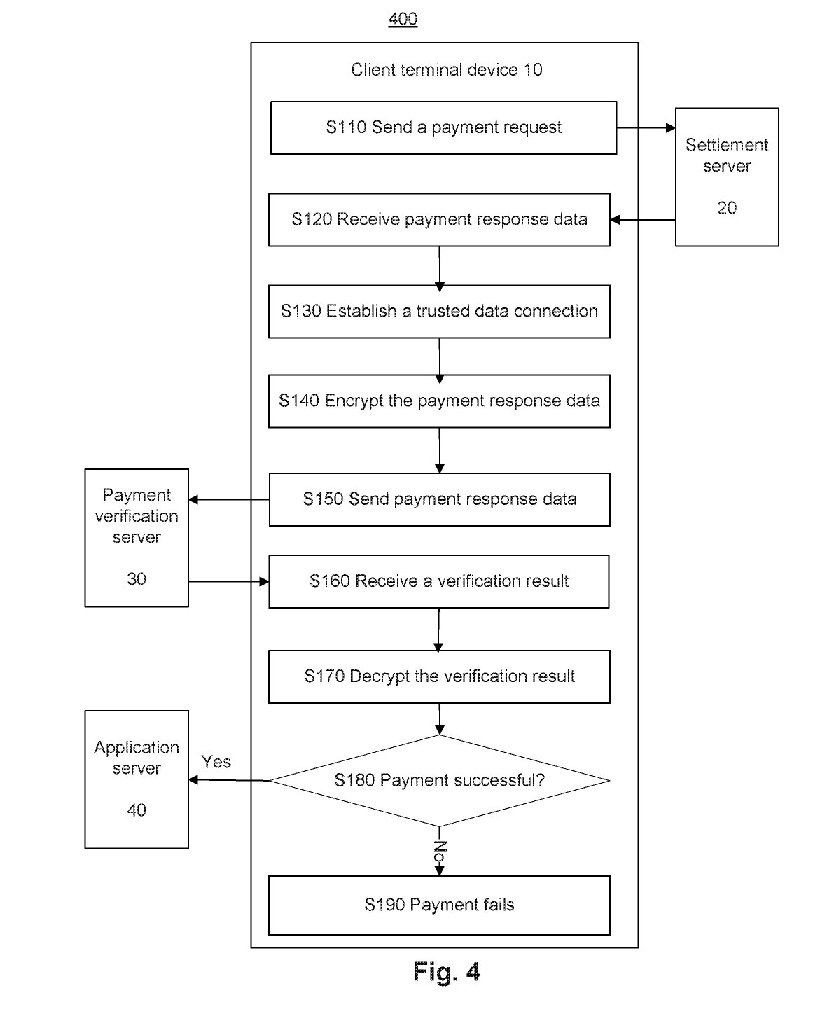

FIG. 3 is a flow diagram illustrating a secure online payment method 300, according to an exemplary embodiment. Method 300 includes Steps S110 to S190 performed on the client terminal device 10, some of which will be described below with reference to FIG. 4. The steps may be executed in a related application (e.g., a game application) installed on the client terminal device 10. Communications with the settlement server 20 in S110 and S120 may also be performed by a store application installed on the client terminal device 10. The client terminal device 10 may perform Step 110 to Step 190.

At Step S110, in response to a purchase or payment instruction from a user, the client terminal device 10 sends a corresponding payment request to the settlement server 20. For example, the related application (e.g., the game application that the user is using) may send a payment request to the settlement server 20 through the store application. Step S110 may be performed by the client terminal device 10.

In some embodiments, the related application on the client terminal device 10 sends the payment request. The payment request may be sent to the settlement server 20 through the store application. Then the settlement server 20 sends payment response data to the related application on the client terminal device 10, so that subsequent verification can be performed.

In some other embodiments, an application on the client terminal device 10 sends the payment request, and another application receives the payment response data, and performs subsequent verification.

In some other embodiments, one client terminal device 10 sends the payment request, and another client terminal device receives the payment response data and performs subsequent verification.

In response to the payment request from the client terminal device 10 (or any other device), the settlement server 20 may complete payment according to a certain settlement procedure, and may send the payment response data to the client terminal device 10.

In one embodiment, the payment response data indicates that payment has been completed in the settlement server, and the payment response data has a signature conforming to a predefined rule. Because the payment response data includes this signature as described above, the payment response data is difficult to simulate or forge. However, the payment response may not be yet verified by this step. The settlement procedure of the settlement server 20 may be consistent with a payment objective being completed according to the payment request.

At Step S120, the client terminal device 10 receives the payment response data from the settlement server 20. For example, the foregoing related application may receive the payment response data from the settlement server 20 through the store application.

At Step S150, the client terminal device 10 sends the payment response data to the payment verification server 30.

In one embodiment, after receiving the payment response data from the client terminal device 10, the payment verification server 30 verifies, according to a predetermined verification method, whether the payment response data has the signature conforming to the predefined rule. Then, the payment verification server 30 sends a verification result to the client terminal device 10. The verification result may indicate whether the payment response data has the signature conforming to the predefined rule, indicating whether the payment response data is authenticate.

At Step S160, the client terminal device 10 receives the verification result from the payment verification server 30.

At Step S180, it can be determined, according to the verification result, whether the payment (described above with reference to Step S110) has been completed in the settlement server 20.

According to the determination result of step S180, item delivery may be performed or a failure prompt may be indicated at the client terminal device. For example, if it is determined (verified) at step S180 that the payment has been completed in the settlement server 20, a notification may be sent to the application server 40, and then item delivery can be completed on the client terminal device 10 by an instruction sent from the application server 40. If it is determined at step S180 that payment is not completed in the settlement server 20 (verification performed by the payment verification server 30 fails, or the payment response data does not carry the foregoing signature), a prompt indicating that payment fails is indicated at the user terminal device at step S190.

The payment response data can be sent to the payment verification server 30, so that the payment verification server 30 verifies the signature. This method can prevent a forged/fake verification result described above with reference to the background, because authentic signature verification is no longer performed by the client terminal device.

FIG. 4 is a flow diagram illustrating another method 400 for secure online payment, according to an exemplary embodiment. Method 400 further includes Steps S130, S140, and S170 in addition to steps described above with reference to method 300 described above.

After Step 120, the method proceeds to Step 130. At step S130, based on a security certificate installed on the client terminal device 10, a trusted data connection between the client terminal device 10 and the payment verification server 30 is established, to send the payment response data (described with reference to Step 150) and receive a verification result (described with reference to Step 160). The security certificate may be downloaded in advance by communications between the client terminal device 10 and the settlement server 20, the payment verification server 30, the application server 40, or another server. The security certificate may be installed on the client terminal device 10, or may be built in the application. The security certificate can be used for verifying validity of the payment verification server 30 and/or validity of an address of the payment verification server 30.

Establishing the trusted data connection using the security certificate can prevent communication between the client terminal device 10 and the payment verification server 30 from being hijacked, and also prevents the payment response data from being submitted to an illegal server. This can ensure that the verification result received by the client terminal device is an authentic verification result.

At Step S140, the payment response data is encrypted, so that the payment response data sent to the payment verification server 30 at step S150 is encrypted payment response data.

After receiving the encrypted payment response data, the payment verification server 30 may first decrypt the encrypted payment response data, and then perform verification.

Encrypting the payment response data can enhance security of data communication between the client terminal device 10 and the payment verification server 30.

A person skilled in the art should understand that the step described in method 300 or 400 may be performed in various orders and some of the steps may be optional. For example, Step S130 may be performed after Step S140, or be performed at the same time, or only either of the steps is performed.

Correspondingly, the payment verification server 30 may encrypt the verification result before sending the verification result to the client terminal device 10. And the verification result received by the payment verification server 30 can be an encrypted verification result.

At Step S170, the encrypted verification result is decrypted, so that at step S180, determination of the success of the payment is performed according to the decrypted verification result. Encryption and decryption of the verification result can enhance security of data communication between the client terminal device and the payment verification server. If the determination result of step S180 is no, the method proceeds to step S190 where payment fails and no item or service is delivered. If the determination result of step S180 is yes, payment is successful and (the ordered) item/service can be delivered on the client terminal device 10 by an instruction sent from the application server 40.

In one embodiment, Step S130, Step S140, and Step S170 may be independent of each other. Any one or two of the steps may be performed, or all of the steps may be performed.

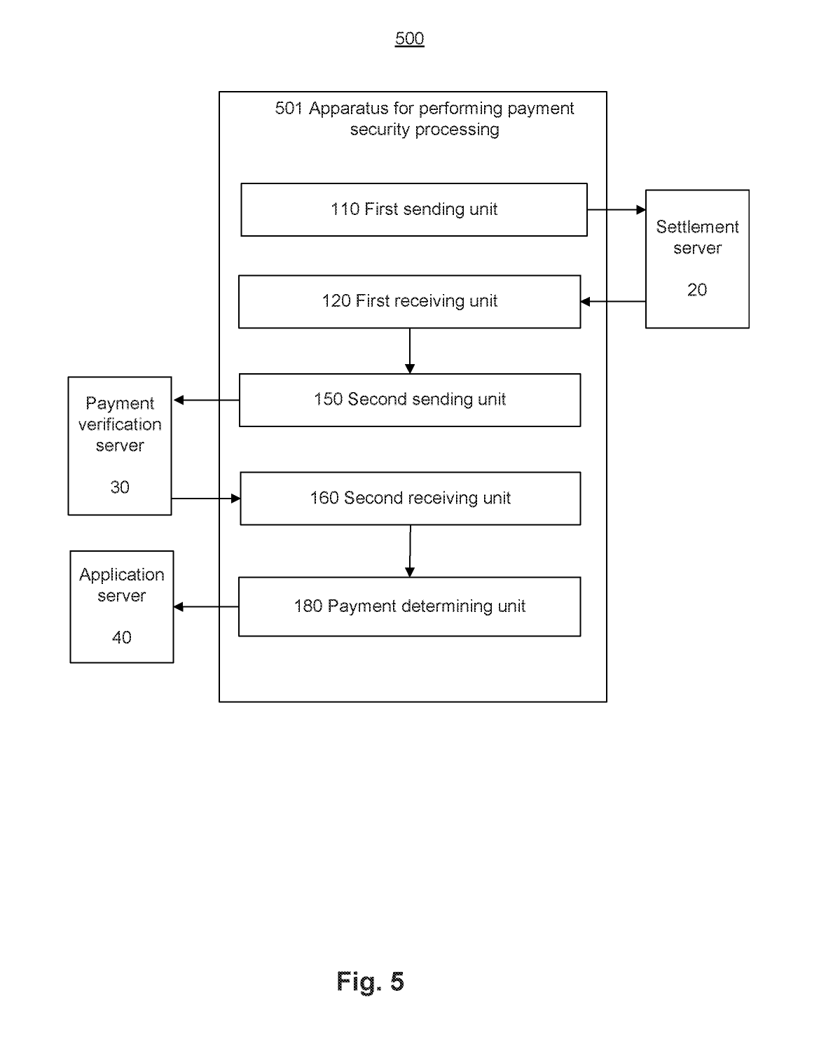

FIG. 5 is a flow diagram illustrating another secure online payment system 500, according to an exemplary embodiment. System 500 may include an apparatus 501 for performing secure payment processing, a settlement server 20, a payment verification server 30. The apparatus 501 may be configured to perform the secure payment processing method described above with reference to FIG. 3 and/or FIG. 4.

The apparatus 501 may include a number of units described below, some of which may be optional.

A first sending unit 110 may be configured to send a payment request to a settlement server 20 in response to a purchase or payment instruction of a user. One application on the client terminal device 10 may send the payment request, and another application may receive payment response data and may perform subsequent verification and processing. In some other embodiments, one client terminal device 10 may send the payment request, and another client terminal device 20 may receive the payment response data and perform subsequent verification. The apparatus performing secure payment processing based on the client terminal device 10 may not include the first sending unit 110.

A first receiving unit 120 may be configured to receive payment response data from the settlement server 20. The payment response data may indicate that payment has been completed in the settlement server 20, and the payment response data may have a signature conforming to a predefined rule.

A second sending unit 150 may be configured to send the payment response data to a payment verification server 30.

A second receiving unit 160 may be configured to receive a verification result from the payment verification server 30. The verification result may indicate whether the payment response data has the signature conforming to the predefined rule.

A payment determining unit 180 may be configured to determine, according to the verification result, whether the payment has been completed in the settlement server 20. When it is determined that payment has been completed, a notification may be sent to an application server 40, to facilitate subsequent item delivery. The payment response data may be sent to the payment verification server.

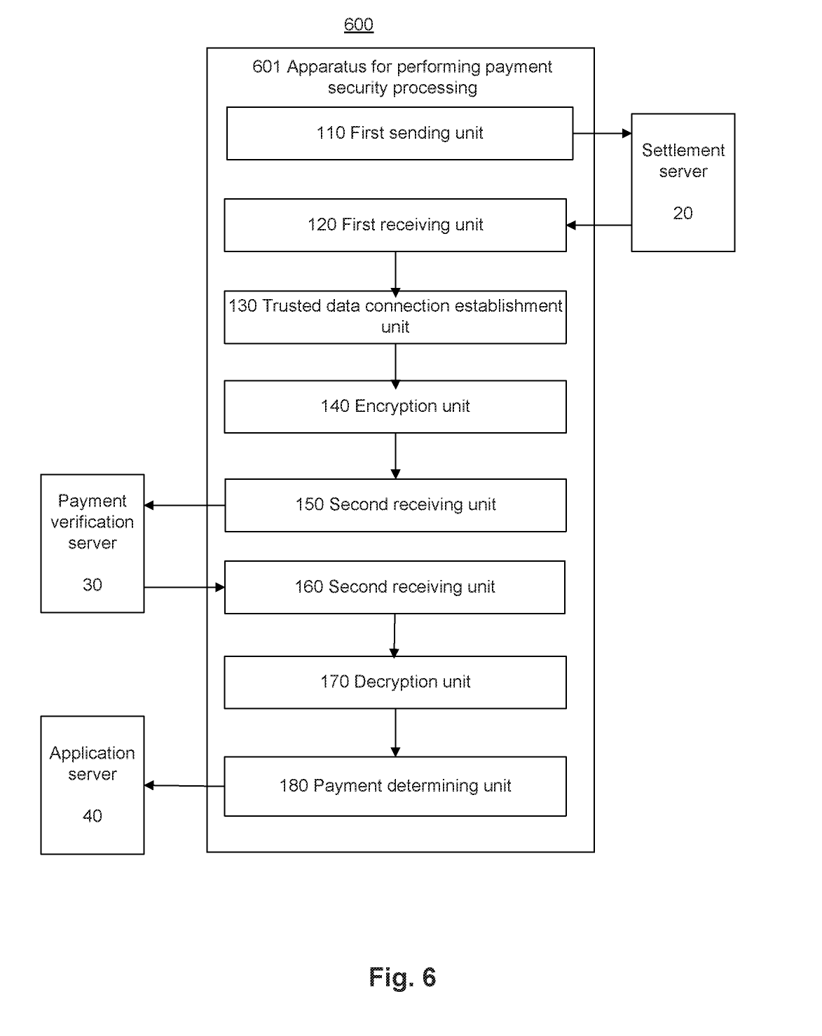

FIG. 6 is a flow diagram illustrating another secure online payment system 600, according to an exemplary embodiment. FIG. 6 may include an apparatus 601 for performing secure payment processing, a settlement server 20, a payment verification server, and an application server 40.

In addition to the units described above with reference to FIG. 5 and apparatus 501, apparatus 601 further includes a trusted data connection establishment unit 130, an encryption unit 140, and a decryption unit 170, some of which may be optional.

The trusted data connection establishment unit 130 may be configured to establish, based on a security certificate installed on the client terminal device 10, a trusted data connection between the client terminal device 10 and the payment verification server 30, allowing sending the payment response data and receiving the verification result.

The security certificate may be downloaded in advance by communications between the client terminal device 10 and the settlement server 20, the payment verification server 30, the application server 40, or another server. The security certificate may be installed on the client terminal device 10, or the security certificate may be built in the application. The security certificate can be used to verify validity of the payment verification server and validity of an address of the payment verification server.

The second sending unit 150 may send the payment response data through the trusted data connection, and the second receiving unit 160 may also receive the verification result through the trusted data connection.

Establishing the trusted data connection using the security certificate can prevent communication between the client terminal device and the payment verification server from being hijacked, and can also prevent the payment response data from being submitted to an illegal server. This can ensure that the verification result received by the client terminal device is an authentic verification result.

The encryption unit 140 may be configured to encrypt the payment response data, so that the payment response data sent by the second sending unit 150 to the payment verification server is encrypted. Encryption of the payment response data can enhance security of data communication between the client terminal device 10 and the payment verification server 30. Correspondingly, the payment verification server 30 may also encrypt the verification result before sending the verification result to the client terminal device 10. The verification result received by the second receiving unit 160 from the payment verification server 30 may be the encrypted verification result.

The decryption unit 170 may be configured to decrypt the encrypted verification result. Encryption and decryption of the verification result can enhance security of data communication between the client terminal device and the payment verification server.

The trusted data connection establishment unit 130, the encryption unit 140 and the decryption unit 170 may be independent of each other. The apparatus 601 may include any one or two of the units, or may include all of the units.

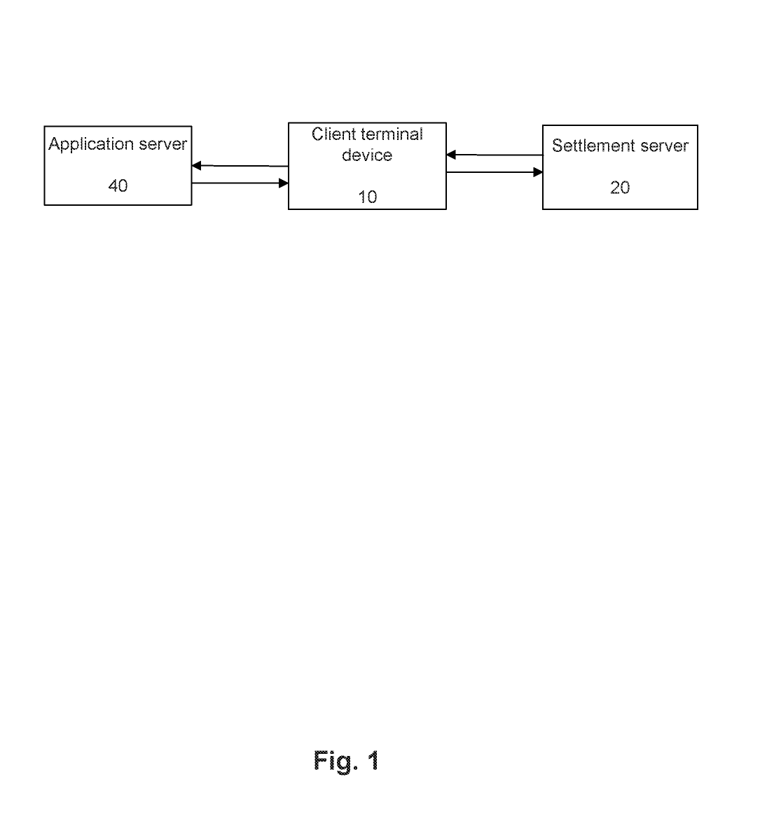

The methods described above may be implemented as a computer program product. The apparatus and/or server described above with reference to FIGS. 1-6 may each include a processor and a non-transitory computer readable medium storing instructions that, when executed by the processor, perform the method(s) described above. The Application(s) described above may be part of the instructions. The (client) terminal device (i.e. an example of the apparatus) may be a cellphone or other types of electronic device.

A person skilled in the art can further understand that, various exemplary logic blocks, modules, circuits, and algorithm steps described with reference to the disclosure herein may be implemented as electronic hardware, computer software, or a combination of electronic hardware and computer software. For examples, the modules/units may be implemented by a processor executing software instructions stored in the computer readable medium.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment or a part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on functions involved. Each block in the block diagram and/or flowchart, and a combination of blocks in the block diagram and/or flowchart may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware. Furthermore, embodiments of the present disclosure may take the form of a computer program product embodied in one or more computer available storage media (including but not limited to a magnetic disk memory, a CD-ROM, an optical memory and so on) containing computer available program codes.

Embodiments of the present disclosure are described with reference to flow diagrams and/or block diagrams of methods, devices (systems) and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general-purpose computer, a special-purpose computer, an embedded processor, or other programmable data processing devices to produce a machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer readable memory that can direct a computer or other programmable data processing devices to function in a particular manner, such that the instructions stored in the computer readable memory produce a manufactured product including an instruction means which implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions which are executed on the computer or other programmable devices provide steps for implementing the functions specified in one or more flows in the flow diagrams and/or one or more blocks in the block diagrams. In a typical configuration, a computer device includes one or more Central Processing Units (CPUs), an input/output interface, a network interface and a memory. The memory may include forms of a volatile memory, a random access memory (RAM) and/or non-volatile memory and the like, such as a read-only memory (ROM) or a flash RAM in a computer readable medium. The memory is an example of the computer readable medium.

The computer readable storage medium refers to any type of physical memory on which information or data readable by a processor may be stored. Thus, a computer readable storage medium may store instructions for execution by one or more processors, including instructions for causing the processor(s) to perform steps or stages consistent with the embodiments described herein. The computer readable medium includes non-volatile and volatile media, removable and non-removable media, wherein information storage can be implemented with any method or technology. Information may be modules of computer readable instructions, data structures and programs or other data. Examples of a computer storage medium include, but are not limited to, a phase-change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices or any other non-transmission media which may be used to store information capable of being accessed by a computer device. The computer readable medium is non-transitory, and does not include transitory media, such as modulated data signals and carrier waves.

The specification has described methods, apparatus, and systems for secure online payment. The illustrated steps are set out to explain the exemplary embodiments shown, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A secure payment processing method, implemented by a client terminal device, comprising:
receiving payment response data indicating that a payment has been completed by a settlement server and having a signature conforming to a predefined rule;
sending the payment response data to a payment verification server;
receiving a verification result from the payment verification server, the verification result indicating whether the payment response data has the signature conforming to the predefined rule; and
determining, according to the verification result, whether the payment has been completed in the settlement server.

2. The secure payment processing method of claim 1, further comprising establishing a trusted data connection between the client terminal device and the payment verification server, based on a security certificate installed on the client terminal device, to send the payment response data and to receive the verification result,
wherein the security certificate verifies the payment verification server and an address of the payment verification server.

3. The secure payment processing method of claim 1, further comprising encrypting the payment response data,
wherein sending the payment response data to the payment verification server includes sending the encrypted payment response data to the payment verification server.

4. The secure payment processing method of claim 1, wherein the verification result received from the payment verification server is an encrypted verification result, and
the method further comprises decrypting the encrypted verification result.

5. An apparatus for performing secure payment processing, comprising:
a first receiving unit configured to receive payment response data indicating that a payment has been completed in a settlement server and having a signature conforming to a predefined rule;
a sending unit configured to send the payment response data to a payment verification server;
a second receiving unit configured to receive a verification result from the payment verification server, the verification result indicating whether the payment response data has the signature conforming to the predefined rule; and
a payment determining unit configured to determine, according to the verification result, whether the payment has been completed in the settlement server.

6. The apparatus of claim 5, further comprising a trusted data connection establishment unit configured to establish a trusted data connection between the client terminal device and the payment verification server, based on a security certificate installed on the client terminal device, wherein:
the security certificate verifies the payment verification server and an address of the payment verification server,
the sending unit is further configured to send the payment response data through the trusted data connection, and
the second receiving unit is further configured to receive the verification result through the trusted data connection.

7. The apparatus of claim 5, further comprising an encryption unit configured to encrypt the payment response data,
wherein sending the payment response data to the payment verification server includes sending the encrypted payment response data to the payment verification server.

8. The apparatus of claim 5, wherein the verification result received from the payment verification server is an encrypted verification result, and
the apparatus further comprises a decryption unit configured to decrypt the encrypted verification result.

9. A secure payment processing method, comprising:
sending, by a client terminal device, a payment request to a settlement server;
completing, by the settlement server, a payment in response to the payment request and sending, by the settlement server, corresponding payment response data to the client terminal device, the payment response data indicating that the payment has been completed in the settlement server and having a signature conforming to a predefined rule;
sending, by the client terminal device, the payment response data to a payment verification server;
verifying, by the payment verification server, whether the payment response data has the signature conforming to the predefined rule;
sending, by the payment verification server, a verification result to the client terminal device; and
determining, by the client terminal device and according to the verification result, whether the payment has been completed in the settlement server.

10. A secure payment processing system, comprising:
a client terminal device configured to send a payment request to a settlement server;
the settlement server configured to complete a payment in response to the payment request and to send corresponding payment response data to the client terminal device, the payment response data indicating that the payment has been completed in the settlement server and having a signature conforming to a predefined rule; and
a payment verification server configured to receive, from the client terminal device, the corresponding payment response data, to verify whether the payment response data has the signature conforming to the predefined rule, and to send a verification result to the client terminal device,
wherein the client terminal device is further configured to determine, according to the verification result, whether the payment has been completed in the settlement server.
